(19) United States
(12) Patent Application Publication
(10) Pub. No.: US 2021/0099786 A1
(43) Pub. Date: Apr. 1, 2021

(54) EARPHONE

(71) Applicant: Chihiro SASAKI, Osaka (JP)

(72) Inventor: Chihiro SASAKI, Osaka (JP)

(21) Appl. No.: 16/942,774

(22) Filed: Jul. 30, 2020

(30) Foreign Application Priority Data
Aug. 19, 2019 (JP) 2019-149811

(51) Int. Cl. H04R 1/10; H04R 1/08

(52) U.S. Cl. CPC H04R 1/1075; H04R 2460/11; H04R 1/1016; H04R 1/086

(57) ABSTRACT

An earphone comprising: a speaker unit which electroacoustic-coverts an audio signal to a sound wave; a microphone unit which acoustic electro-convers a sound wave to an audio signal; and a housing which mounts the speaker unit and the microphone unit in an inside of the housing; wherein the housing defines a first acoustic space at one side of a diaphragm of the speaker unit, arranges the microphone unit at a side of a second acoustic space which is defined at the other side of the diaphragm and does not communicate with the first acoustic space, and includes an opening which communicates a front room space of the microphone unit with an external space, a microphone cover member which defines the front room space with the microphone unit, and a waterproof ventilation member which is mounted on the microphone cover member, covers the microphone cover member so that a waterdrop does not invade to a sound hole of the microphone unit which communicates with the front room space and has ventilation.

### CROSS-REFERENCE TO RELATED APPLICATIONS

This application claims priority to Japanese Application No. 2019-149811, filed Aug. 19, 2019, the entire contents of which are incorporated herein by reference.

### FIELD

The present disclosure relates to an earphone which is mounted on an ear of a user and reproduces an audio and especially relates to an earphone which includes a microphone which converts an audio into an audio signal and in which an exit of a reproduced sound wave is inserted into an external auditory meatus entrance of a user.

### BACKGROUND

A headphone and an earphone reproduce a sound by applying an audio signal to a speaker unit which is arranged so as to abut on an ear of a user. In the earphone which is mounted on the ear of the user, there are various embodiments. For example, there is the one which includes a relatively large speaker unit like a headphone and an ear hook part which is mounted so as to put a main body on an ear canal. Further, there is an inner ear type that a main body part is mounted so that the main body part is accommodated in an inside of the ear canal, which is used by radiating a sound from a radiation surface of the main body part to an external auditory meatus. Further, an earphone of a type which is called a canal type is popular. The canal type earphone is mounted so that the main body part is accommodated in an inside of an ear canal and is used by inserting a sound cylindrical part which protrudes from the main body part and an ear piece which is mounted at the sound cylindrical part into the external auditory meatus.

For example, conventionally, there is an earphone which prevents a deterioration of a sound quality which is caused by “a muffing” of a sound which occurs by a sealing of a space which is surrounded by an eardrum, the speaker unit and the ear canal mounting member by a speaker unit, a housing, an ear canal mounting member, a first ventilation resistor, and a second ventilation resistor (JP 2000-341784 A). The speaker unit includes a diaphragm accommodating part. The housing accommodates the speaker unit, and in the housing, an opening which radiates a sound from a front surface side of the speaker unit, a first ventilation hole, and a second ventilation hole are forming. The ear canal mounting member is arranged with surrounding the opening and has elastic. The first ventilation resistor communicates a first space with an outside of the earphone by interposing the first space which is composed when mounting to the ear canal and is surrounded by an eardrum, the speaker unit, and the ear canal mounting member and the first ventilation hole. The second ventilation resistor communicates a second space with the outside of the earphone by interposing the second space of a rear surface of the diaphragm of the speaker unit and the second ventilation hole.

Further, conventionally, for example, there is an earphone microphone including: one speaker; a microphone which has a first and a second sound collection holes; and a main body enclosure that an acoustic space is formed. The acoustic space includes a sound emission passage that an output audio of the speaker propagates, a first sound collection passage which communicates with an outside of the main body enclosure and that an audio which is input to the first collection hole, and a second sound collection passage that an audio which is input to the second collection hole. The sound emission passage branches to one route which communicates with an outside of the main body enclosure and the other route which communicates with the second sound collection passage. An input audio from an outside sound source is collected and a collection of an output audio of the speaker is suppressed by an acoustic resistor of the acoustic space (JP 2014-187679 A).

Further, conventionally, there is an earphone which includes a waterproof mesh which covers a sound emission hole of the earphone and has a waterproof performance (JP 2011-082701 A). A waterproof is realized by preventing an invasion of water from the sound emission hole which is provided at a housing.

However, in an earphone including a microphone also, to further have a waterproof performance is expected. The earphone including the microphone includes the waterproof performance, and a problem that the acoustic characteristics of a speaker unit and a microphone unit deteriorates or the earphone including the microphone cannot be used does not occur is expected even if water splashes.

### SUMMARY OF THE DISCLOSURE

According to one aspect of the disclosure, there is provided An earphone comprising: a speaker unit which electroacoustic-coverts an audio signal to a sound wave; a microphone unit which acoustic electro-convers a sound wave to an audio signal; and a housing which mounts the speaker unit and the microphone unit in an inside of the housing; wherein the housing defines a first acoustic space at one side of a diaphragm of the speaker unit, arranges the microphone unit at a side of a second acoustic space which is defined at the other side of the diaphragm and does not communicate with the first acoustic space, and includes an opening which communicates a front room space of the microphone unit with an external space, a microphone cover member which defines the front room space with the microphone unit, and a waterproof ventilation member which is mounted on the microphone cover member, covers the microphone cover member so that a waterdrop does not invade to a sound hole of the microphone unit which communicates with the front room space and has ventilation.

### BRIEF DESCRIPTION OF THE DRAWINGS

FIG. 1 is a diagram for describing an earphone according to a preferable embodiment of the present disclosure (Embodiment 1).

FIG. 2 is a diagram for describing an inside structure of the earphone according to a preferable embodiment of the present disclosure (Embodiment 1).

FIG. 3 is an enlargement diagram for describing an inside structure of the earphone according to a preferable embodiment of the present disclosure (Embodiment 1).

FIG. 4 is an enlargement diagram for describing an inside structure of an earphone according to the other preferable embodiment of the present disclosure (Embodiment 2).

FIG. 5 is a diagram for describing a microphone cover member of the earphone according to the other preferable embodiment of the present disclosure (Embodiment 2).

### DETAILED DESCRIPTION OF THE PREFERRED EMBODIMENTS

The disclosure is made for solving a problem that the above described conventional technology has, an objective of the present disclosure is to provide an earphone which has waterproof performance and realizes clear and preferable audio reproduction in relate to the earphone including a microphone which converts an audio into an audio signal which is mounted on an ear of a user and reproduces an audio, especially.

An earphone including a microphone according to preferable embodiments of the present disclosure is described below. However, the present disclosure is not limited to these embodiments.

### Embodiment 1

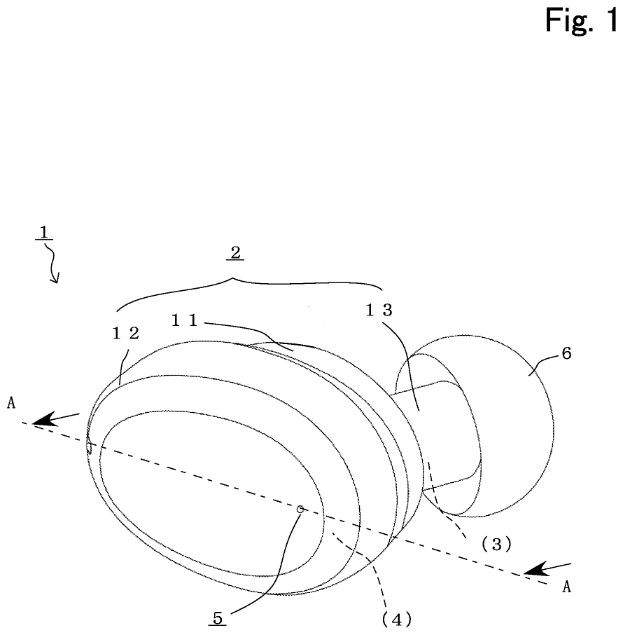

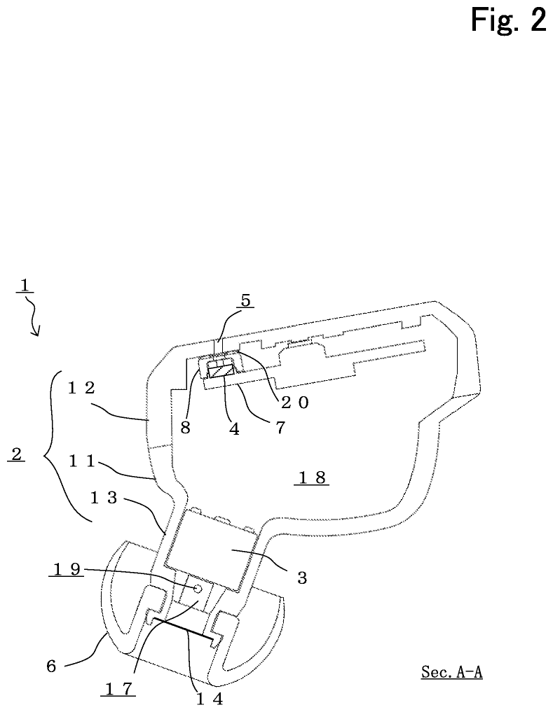

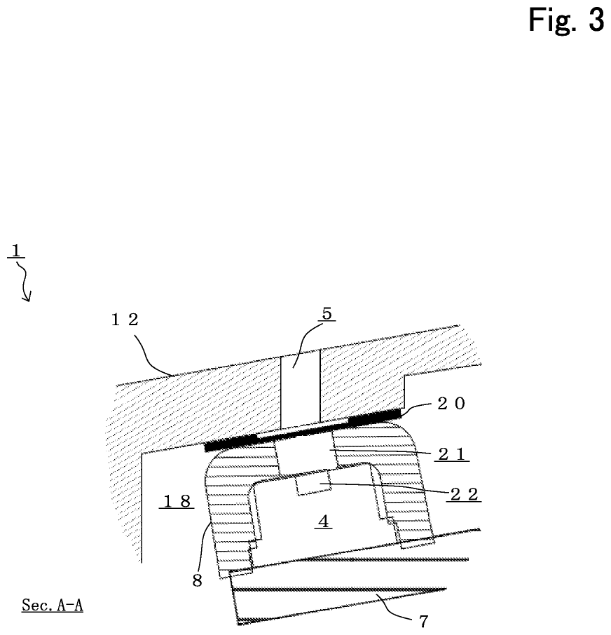

Each of FIGS. 1-3 is a diagram for describing an earphone 1 according to a preferable embodiment of the present disclosure. Concretely, FIG. 1 illustrates a perspective diagram of the earphone 1 which is mounted on one ear of a user. Further, FIG. 2 is a cross sectional diagram of A-A′ cross section of FIG. 1 and a cross sectional diagram of an inside structure of the earphone 1. Further, FIG. 3 is a partial enlargement cross sectional diagram surrounding an opening 5 of a housing 2 of the earphone 1 and a cross sectional diagram for describing an inside structure of the earphone 1. Further, with regard to the other unnecessary configuration of the earphone 1 for description of the present disclosure, illustration and description are omitted.

The earphone 1 according to the present embodiment is a canal type earphone that an exit of a reproduced sound wave is inserted into an external auditory meatus hole of an ear canal of a user. The earphone 1 includes almost left and right symmetrical shape earphones which are respectively mounted on left and right ears of the user and can handle a stereo reproduction. A configuration corresponding to one ear of the earphone 1 is described below. An embodiment of the earphone 1 is not limited to a case of the present embodiment.

The earphone 1 includes a speaker unit 3 which electroacoustic-converts an audio signal into a sound wave, a microphone unit 4 which acoustic electro-converts a sound wave into an audio signal, a housing 2 that the speaker unit 3 and the microphone unit 4 are mounted in an inside of the housing 2 and there is a case where the earphone 1 is called an earphone microphone or a headset. The earphone 1 includes a battery (not shown) in an inside of the housing 2 and a wireless communication circuit (not shown) is arranged on a circuit substrate 7 which wirelessly communicates with the other electronic device (not shown). Therefore, the earphone 1 of the present embodiment reproduces an audio from the speaker unit 3 by supplying an audio signal not via a cord and further, composes a wireless earphone with a microphone which can wirelessly communicate a sound of an external space which is collected by the microphone unit 4.

The speaker unit 3 of the earphone 1 includes a magnetic circuit (not shown) which has a magnetic cavity and is an electrodynamic type electroacoustic convertor which vibrates a diaphragm (not shown) which is connected to a voice coil (not shown) which is inserted into the magnetic cavity and that an audio signal is supplied. The speaker unit 3 radiates the sound wave which becomes to an opposite phase relationship against a front surface side and a rear surface side of the diaphragm. Therefore, in the housing 2, the speaker unit 3 is necessary to be mounted so that one side and the other side of the diaphragm of the speaker unit 3 are separate.

In the housing 2 of the present embodiment, the speaker unit 3 of a diameter corresponding to a size of the external auditory meatus hole of the ear canal of the user can be mounted. The housing 2 includes an almost cylindrical shape base member 11 including a nozzle part 13 and a housing member 12 which is connected to a rear side of the base member 11 and composes a cavity. The base member 11 and the housing member 12 of the housing 2 define an acoustic space 17 in a front side of the diaphragm of the speaker unit 3 and form an acoustic space 18 which is separate from the acoustic space 17 in a rear side that the magnetic circuit of the speaker unit 3 exists.

The base member 11 is made of a metal material or a resin material and includes a speaker unit mounting member which mounts the speaker unit 3 on an inside wall part. An outer diameter frame of the speaker unit 3 has an outer size which is almost identical to an inner diameter size of a speaker unit mounting member of the almost cylindrical shape base member 11. The base member 11 includes the nozzle part 13 in which a front end side is formed thinly so that the nozzle part 13 is inserted into the external auditory meatus hole of the ear canal of the user. The nozzle part 13 forms an acoustic passage which communicates with the acoustic space 17 and leads a sound wave to the external auditory meatus in an inside of the nozzle part 13.

An ear piece mounting member for mounting the ear piece 6 is formed on an outer circumference surface of the nozzle part 13 of the base member 11. When the umbrella shape ear piece 6 which has elastic is mounted, a canal type earphone that the ear piece 6 adheres to the external auditory meatus. The user can stably mount the earphone 1 on an auricula by the ear piece 6. A waterproof ventilation member 14 as a protection member which has a ventilation is mounted at an opening end part of the nozzle part 13. Even if water splashes, the waterproof ventilation member 14 prevents a malfunction that water invades from the opening end part of the nozzle part 13 to an inside and the earphone 1 cannot be used or foreign substances are mixed and the acoustic passage is closed.

As illustrated in FIGS. 2 and 3, the microphone unit 4 of the earphone 1 is arranged in the acoustic space 18 which is defined by the housing member 12 and converts an external space of a sound wave through the opening 5 of the housing 2 into an electric signal. The microphone unit 4 is mounted on the circuit substrate 7 which is mounted in an inside side of the housing member 12 and is arranged in the acoustic space 18. For example, the microphone unit 4 may be a MEMS (Micro Electro Mechanical Systems) or a piezoelectric type microphone device and outputs an electric signal based on a sound pressure level which is added to a diaphragm (not shown) through that sound hole 22.

As illustrated in FIG. 3, the microphone unit 4 is covered and accommodated by a microphone cover member 8 which is formed in an almost rectangular parallelepiped shape based on an outer shape of the microphone unit 4 by a flexible rubber member or an elastomer resin member. The microphone cover member 8 defines a front room space 21 with the microphone unit 4 and this front room space 21 communicates with the opening 5 of the housing 2 and the sound hole 22 of the microphone unit 4. The microphone cover member 8 defines the front room space 21 between the microphone unit 4 and the housing member 12 by the thickness of the microphone cover member 8. The waterproof ventilation member 20 is mounted on the microphone cover member 8. In the microphone cover member 8, an upper surface side abuts on the waterproof ventilation member 20 and a lower surface side abuts on one surface of the circuit substrate 7. The microphone cover member 8 may be formed by a resin material or an elastic body which has flexibility and be composed so as to also include the circuit substrate 7 which fixes the microphone unit 4.

The waterproof ventilation member 20 is arranged between the housing 2 and the microphone cover member 8 so as to cover the opening 5 of the housing 2 and that surrounding. The waterproof ventilation member 20 is a protection member similarly to the waterproof ventilation member 14 which is mounted at an opening end part of the nozzle part 13 and a member which has flexibility. The waterproof ventilation member 20 prevents malfunction that water invades to an inside of the earphone 1 from an opening end part of the nozzle part 13 and the earphone 1 cannot be used or foreign substances are mixed and the acoustic passage is closed. For example, the waterproof ventilation member 20 may be a cloth shape or a film shape mesh member which is water-repellent finished and prevents that water invades to the front room space 21 which is defined by the microphone cover member 8 of an inside side of the opening 5 from the opening 5 of the housing 2.

As a result, for example, the earphone 1 can satisfy a waterproof performance which is not less than a predetermined IP code number in an IPX standard. Even if water splashes to the earphone 1 experimentally, water does not invade to an inside of the housing 2 to an extent that the earphone 1 cannot be used. Therefore, the earphone 1 of the present embodiment can realize waterproof performance to be expected.

The base member 11 may include a leak hole or a leak port 19 as a first acoustic passage which communicates with the acoustic space 17 and leads a sound wave to an external space. Further, since the housing member 12 defines the acoustic space 18 which is formed separately from the acoustic space 17, a leak port (not shown) which forms a second acoustic passage which communicates with this acoustic space 18 and leads a sound wave to an external space may be included further. For example, the leak port may compose the acoustic passage by using a tube which is a hollow cylindrical member in which a material is a silicon resin which has flexibility. It is preferable that a length and an inner diameter of the tube of the leak port are adjusted based on an air chamber volume of the acoustic space 18. Further, the leak port may be a hollow cylindrical material which has a flexibility which can obtain a necessary inner diameter size and a material of the leak port is not limited to the silicon resin. The leak port may be other than the silicon resin and a rubber material, an elastomer resin material, or a PVC (polyvinyl chloride) resin material, for example.

It is preferable that a waterproof ventilation member is provided at this leak hole or leak port so that water does not invades inside. Further, instead of the waterproof ventilation member, an acoustic resistor member which limits a ventilation of the leak hole or leak port and has flexibility may be arranged. Ina canal type earphone 1, it is preferable that the leak hole or leak port which is an appropriate acoustic passage is formed so as to obtain appropriate sound pressure frequency characteristics. In the earphone 1 of the present embodiment, since the housing 2 includes a leak hole or port which forms an acoustic passage which communicates with the acoustic space 17 and/or the acoustic space 18 and leads a sound wave to an external space, about 300 Hz-1 kHz is improved to be flat characteristics and clearance of reproduction audio can be improved when comparing an earphone 10 (not shown) of a comparison example which does not include a leak hole or port. As a canal type earphone 1 that an exit of reproduced sound wave is inserted into an entrance of an external auditory meatus of the user, natural and preferable audio reproduction can be realized when comparing the earphone 10 of the comparison example.

### Embodiment 2

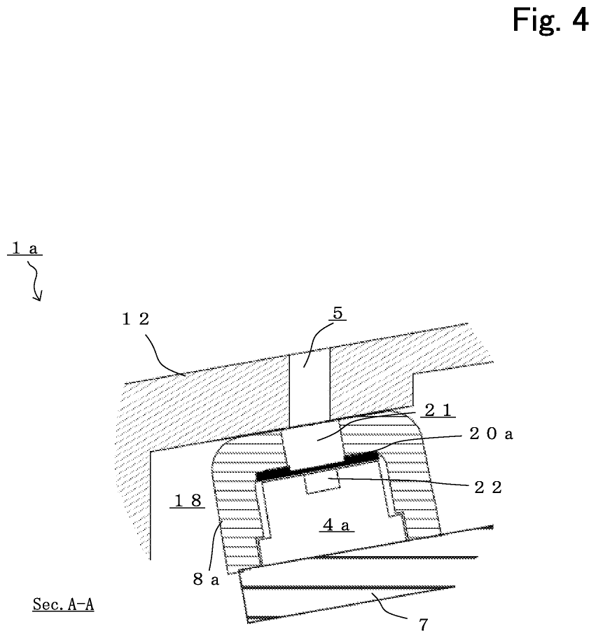

FIG. 4 is a diagram for describing an earphone 1a according to the other preferable embodiment of the disclosure. Concretely, FIG. 4 is a partial enlargement cross sectional diagram of surrounding of the opening 5 in the housing 2 of the earphone 1a corresponding to FIG. 3 in the previous embodiment and a cross sectional diagram for describing an inside structure of the earphone 1a.

When comparing the earphone 1a and the earphone 1 of the previous embodiment, a mounting structure of a microphone cover member 8a and a waterproof ventilation member 20a is different and the earphone 1a has an almost common configuration with the earphone 1 of the previous embodiment. Therefore, with regard to the other unnecessary configuration of the earphone 1a for description of the present disclosure, illustration and description are omitted. An embodiment of the earphone 1a is not limited to a case of the present embodiment.

As illustrated in FIG. 4, a microphone unit 4a of the earphone 1a is arranged in the acoustic space 18 which is defined by the housing member 12 and converts a sound wave of an external space through the opening 5 of the housing 2 into an electric signal. The microphone unit 4a is covered and accommodated by a microphone cover member 8a which is formed in an almost cylindrical shape based on an outer shape of the microphone unit 4a.

The microphone cover member 8a defines a front room space 21 with the microphone unit 4a and this front room space 21 communicates with the opening 5 of the housing 2 and a sound hole 22 of the microphone unit 4a. In the microphone cover member 8a, an upper surface side abuts on an inside surface side of the housing member 12 and a lower surface side abuts on one surface of the circuit substrate 7. The microphone cover member 8a defines the front room space 21 between the microphone unit 4 and the housing member 12 by a thickness of the microphone cover member 8a. Further, the waterproof ventilation member 20a is mounted at the microphone cover member 8a.

The waterproof ventilation member 20a is arranged between the microphone cover member 8a and the microphone unit 4a and the microphone cover member 8a covers surrounding of the opening 5 of the housing 2. The waterproof ventilation member 20a is a protection member which has ventilation similarly to the waterproof ventilation member 20 of the previous embodiment and can prevent that water reaches the microphone unit 4a even if water invades to the front room space 21 which is defined by the microphone cover member 8 of an inside of the opening 5 of the housing 2.

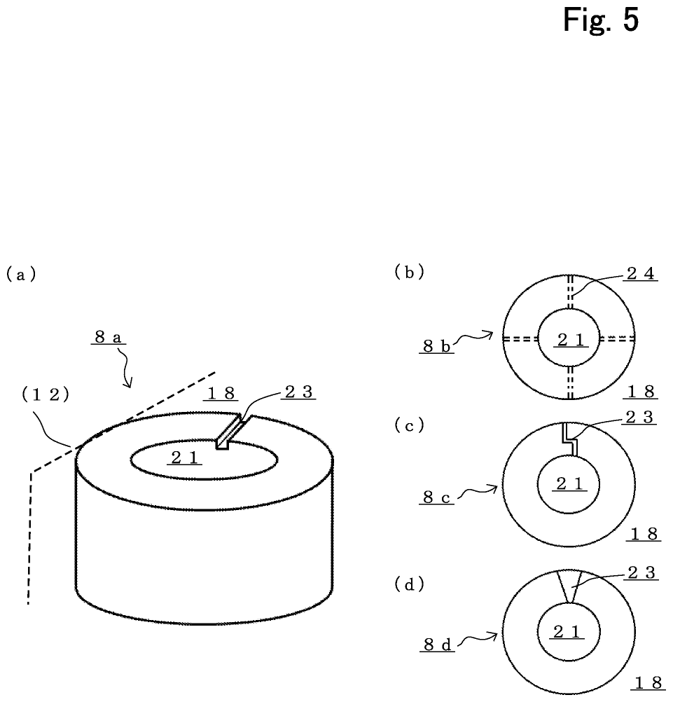

FIG. 5 is a diagram for describing this microphone cover member 8a and microphone cover members 8b-8d of that variation example. Concretely, FIG. 5(a) is a perspective diagram of the microphone cover member 8a and each of FIGS. 5(b)-5(d) is a top diagram of each of the microphone cover members 8b-8d. As illustrated in FIGS. 5(a)-5(d), a groove 23 or a hole 24 which communicates the acoustic space 18 which is defined by the housing member 12 of the housing 2 with the opening 5 and the front room space 21 is formed at each of the microphone cover members 8a-8d.

For example, in the microphone cover member 8a illustrated in FIG. 5(a), one groove 23 which is a straight shape and in which a width and a depth are constant is provided at an upper surface end which abuts on an inside surface of the housing member 12. Since this groove 23 communicates the acoustic space 18 with the front room space 21, an acoustic passage as a leak port which leads a sound wave from the acoustic space 18 to an external space through the opening 5. Further, in the microphone cover member 8b illustrated in FIG. 5(b), four holes 24 which are straight shapes and in which a width and a depth are constant are provided at a side surface of an almost cylindrical shape base. In the earphone 1a of the present embodiment, like the microphone cover member 8a or 8b, since a leak port as an acoustic passage which communicates with the acoustic space 18 and leads a sound wave to an external space can be designed variously, appropriate sound pressure frequency characteristics can obtain and natural and preferable audio reproduction can be realized.

Further, in the microphone cover member 8c illustrated in FIG. 5(c), one groove 23 which includes a part which is bent is provided at an upper end which abuts on an inside surface side of the housing member 12. Even if water invades to the front room space 21 from the opening 5 of the housing 2, water can be hard to reach the acoustic space 18 which is an inside of the housing member 12 by the groove 23 which includes the bent part. The groove 23 may be bent in a crank shape like the present embodiment, and further, at least a bent point which is rapidly bent may be included.

Further, in the microphone cover member 8d as illustrated in FIG. 5(d), one groove 23 in which a cross sectional area expands toward an outer diameter side from an inner diameter side is provided at an upper surface end which abuts on an inner surface side of the housing member 12. In this groove 23, since a cross sectional area of a part which faces to the front room space 21 of an inner side is small, water can be hard to reach the acoustic space 18 of an outer diameter side by the groove 23.

In the earphone 1a of the present embodiment, like the microphone cover member 8c or 8d, since a leak port as the acoustic passage which communicates with the acoustic space 18 and leads a sound wave to an external space can be designed with considering waterproof performance, appropriate sound pressure frequency characteristics can be obtained and a natural and preferable audio reproduction can be realized. Since the groove 23 or the hole 24 of each of the microphone cover members 8a-8d becomes to a leak port which the acoustic space 18 and the opening 5 and the front room space 21, a waterproof ventilation member may be provided so that water does not invade inside. Further, instead of the waterproof ventilation member, an acoustic resistor member which limits ventilation of the groove 23 or the hole 24 and has ventilation may be arranged.

When the earphone 1 or 1a is not a wireless earphone, the housing member 12 may be made of a metal material or a resin material and a cord bush which fixes a cord which supplies an audio signal to the speaker unit 3 maybe connected to the housing member 12. The cord bush maybe formed by a flexible rubber material so as to include the cord inside and one side may be connected to a mounting hole of the housing member 12. Further, in case of the earphone 1 or 1a that a jack for plug connection is provided at the housing 2, the housing member 12 may include a jack that a plug which is a front end of the cord is inserted as a cord connection part which connects a cord which supplies the audio signal to the speaker unit 3 instead of the cord bush.

The earphone of the present disclosure is not limited to a canal type earphone as illustrated and may be an earphone which further includes another ear hook part. Further, not limited to the earphone, an overhead type earphone may be composed by connecting earphones corresponding to left and right ears by a headband. Not limited to a stereo reproduction for home or a multichannel surround reproduction, the earphone can be also applied to an on-vehicle audio device and an acoustic reproduction facility such as a theater etc.

What is claimed is:

1. An earphone comprising:
a speaker unit which electroacoustic-coverts an audio signal to a sound wave;
a microphone unit which acoustic electro-convers a sound wave to an audio signal; and
a housing which mounts the speaker unit and the microphone unit in an inside of the housing;
wherein the housing defines a first acoustic space at one side of a diaphragm of the speaker unit, arranges the microphone unit at a side of a second acoustic space which is defined at the other side of the diaphragm and does not communicate with the first acoustic space, and includes an opening which communicates a front room space of the microphone unit with an external space, a microphone cover member which defines the front room space with the microphone unit, and a waterproof ventilation member which is mounted on the microphone cover member, covers the microphone cover member so that a waterdrop does not invade to a sound hole of the microphone unit which communicates with the front room space and has ventilation.

2. The earphone according to claim 1,
wherein the waterproof ventilation member is arranged between the hosing and the microphone cover member so as to cover the opening of the housing and surrounding of the opening.

3. The earphone according to claim 1,
wherein the waterproof ventilation member is arranged between the microphone cover member and the microphone unit and the microphone cover member covers surrounding of the opening of the housing.

4. The earphone according to claim 3,
wherein the microphone cover member has a groove or a hole which communicates the second acoustic space with the opening and the front room space.

5. The earphone according to claim 1,
wherein the housing has a second acoustic passage communicates with the second acoustic space and leads a sound wave to the external space.

6. The earphone according to claim 5,
wherein the housing arranges an acoustic resistor member which has ventilation at the second acoustic passage.

7. The earphone according to claim 1,
wherein the housing has a first acoustic passage which communicates with the first acoustic space and leads a sound wave to the external space.

8. The earphone according to claim 7,
wherein the housing arranges an acoustic resistor member which has ventilation at the first acoustic passage.

9. The earphone according to claim 1,
wherein the housing includes a nozzle part which forms an acoustic passage which communicates with the first acoustic space and leads a sound wave to an external auditory meatus, and an ear piece mounting member which is provided at a front end of the nozzle part and that an ear piece which is inserted into the external auditory meatus of the user is mounted, and
further comprising: the ear piece which is mounted at the ear piece mounting member.
